(19) United States
(12) Patent Application Publication
(10) Pub. No.: US 2013/0011731 A1
(43) Pub. Date: Jan. 10, 2013

(54) CATHODE SLURRY COMPOSITION, CATHODE PREPARED FROM THE SAME, AND LITHIUM BATTERY COMPRISING THE CATHODE

(75) Inventors: Hye-Sun JEONG, Yongin-si (KR); Jun-Kyu Cha, Yongin-si (KR); Seung-Hun Han, Yongin-si (KR); Ki-Jun Kim, Yongin-si (KR)

(73) Assignee: Samsung SDI Co., Ltd., Yongin-si (KR)

(21) Appl. No.: 13/470,111

(22) Filed: May 11, 2012

(30) Foreign Application Priority Data
Jul. 4, 2011 (KR) 10-2011-0066120

(51) Int. Cl. H01M 4/66; H01M 4/48; H01M 4/583

(52) U.S. Cl. 429/211; 252/182.1; 252/518.1; 252/506; 252/512; 252/519.33

(57) ABSTRACT

A cathode slurry composition, a cathode prepared from the same, and a lithium battery comprising the cathode. The cathode slurry composition may include an aqueous binder, a cathode active material, and a non-transition metal oxide.

### CROSS-REFERENCE TO RELATED APPLICATIONS

This application claims the benefit of Korean Patent Application No. 10-2011-0066120, filed on Jul. 4, 2011, in the Korean Intellectual Property Office, the disclosure of which is incorporated herein by reference.

### BACKGROUND

1. Field

One or more embodiments relate to a cathode slurry composition, a cathode prepared from the same, and a lithium battery comprising the cathode.

2. Description of the Related Technology

When a water-containing aqueous cathode slurry composition is coated on an aluminum current collector, hydrogen ions or hydroxyl ions in the cathode slurry composition react with the aluminum, thus causing corrosion of the aluminum and generating hydrogen.

Consequently, an insulator layer, such as alumina (Al₂O₃), may be formed on a surface of the aluminum, causing an increase in resistance, and cracks or pores in an active material composition layer by air bubbles, which may deteriorate batteries.

### SUMMARY

One or more embodiments include a cathode slurry composition comprising a non-transition metal oxide able to prevent corrosion of an aluminum current collector.

One or more embodiments include a cathode prepared from the cathode slurry composition.

One or more embodiments include a lithium battery comprising the cathode.

Additional aspects will be set forth in part in the description which follows and, in part, will be apparent from the description, or may be learned by practice of the presented embodiments.

According to one or more embodiments, a cathode slurry composition includes an aqueous binder as a first binder, a cathode active material, and a non-transition metal oxide.

According to one or more embodiments, a cathode includes a cathode composition layer formed using the above cathode slurry composition, and an aluminum current collector.

According to one or more embodiments, a lithium battery includes the above cathode.

### BRIEF DESCRIPTION OF THE DRAWINGS

These and/or other aspects will become apparent and more readily appreciated from the following description of the embodiments, taken in conjunction with the accompanying drawings of which:

FIG. 1A is a scanning electron microscopic (SEM) image of a surface of a cathode manufactured in Example 1;

FIG. 1B is a SEM image of a surface of a cathode manufactured in Comparative Example 1; and

FIG. 2 is a schematic view of a lithium battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

Hereinafter, one or more embodiments of a cathode slurry composition, a cathode prepared from the same, and a lithium battery comprising the cathode will be described in greater detail.

According to an embodiment, a cathode slurry composition includes an aqueous binder as a first binder, a cathode active material, and a non-transition metal oxide. The cathode slurry composition is a water-based aqueous cathode slurry composition.

The cathode slurry composition includes a non-transition metal oxide. Hydrogen ions and/or hydroxyl ions present in the cathode slurry composition react with the non-transition metal oxide to form an inert compound with respect to aluminum. Thus, when the cathode slurry composition is coated on an aluminum current collector, hydrogen ions and/or hydroxyl ions are less likely to react with aluminum, so that corrosion of the aluminum may be prevented.

The prevention of aluminum corrosion may prevent formation of an insulating layer such as alumina on a surface of the current collector and an increase in cathode resistance. Furthermore, generation of hydrogen gas by the reaction of aluminum and hydroxyl ions may be suppressed, thus preventing generation of pores or cracks in a surface of a cathode metal mixture layer.

The non-transition metal oxide may include an oxide of at least one element selected from the group consisting of lithium (Li), beryllium (Be), boron (B), sodium (Na), magnesium (Mg), aluminum (Al), silicon (Si), potassium (K), calcium (Ca), gallium (Ga), germanium (Ge), arsenic (As), selenium (Se), rubidium (Rb), strontium (Sr), indium (In), tin (Sn), antimony (Sb), tellurium (Te), cesium (Cs), barium (Ba), thallium (Tl), lead (Pb), bismuth (Bi), and polonium (Po). In some embodiments, the non-transition metal oxide may be at least one selected from the group consisting of MgO, SiO₂, Al₂O₃, In₂O₃, and SnO₂.

For example, if MgO is added as the non-transition metal oxide, water in the cathode slurry composition is removed by a reaction according to Reaction Scheme 1 below. Thus, hydroxyl ions originating from water may be not be generated.

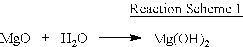

The non-transition metal oxide of the cathode slurry composition may be in powder form having an average particle diameter of from about 1 μm or less. The non-transition metal oxide may be in nanopowder form having an average particle diameter of from about 1 nm to about 999 nm, but is not limited to the average particle diameter, and may have any particle diameter appropriate for an effective anti-corrosion effect of aluminum and improved battery characteristics. If the average particle diameter is too small, the anti-corrosion effect may be trivial. If the average particle diameter is too large, dispersion of the non-transition metal oxide in the cathode slurry composition may be non-uniform. For example, the non-transition metal oxide may have an average particle diameter of from about 1 nm to about 900 nm. In some embodiments the non-transition metal oxide may have an average particle diameter of from about 100 nm to about 900 nm. In some other embodiments the non-transition metal oxide may have an average particle diameter of from about 500 nm to about 900 nm. In some other embodiments the non-transition metal oxide may have an average particle diameter of from about 700 nm to about 900 nm. In some embodiments the non-transition metal oxide may have an average particle diameter of from about 750 nm to about 850 nm.

When the non-transition metal oxide has an average particle diameter of from about 750 nm to about 850 nm, it may exhibit improved dispersibility.

An amount of the non-transition metal oxide in the cathode slurry composition may be from about 1 part to about 15 parts by weight based on 100 parts by weight of the cathode active material. In some embodiments, the amount of the non-transition metal oxide may be from about 1 part to about 12 parts by weight based on 100 parts by weight of the cathode active material. In some other embodiments, the amount of the non-transition metal oxide may be from about 1 part to about 10 parts by weight based on 100 parts by weight of the cathode active material. If the amount of the non-transition metal oxide is too small, the anti-corrosion effect on the aluminum current collector may not be attainable. If the amount of the non-transition metal oxide is too large, the non-transition metal oxide may not be dispersible, and rather, may agglomerate in the cathode slurry composition.

The cathode active material of the cathode slurry composition may include at least one selected from the group consisting of lithium cobalt oxide, lithium nickel cobalt manganese oxide, lithium nickel cobalt aluminum oxide, lithium iron phosphorous oxide, and lithium manganese oxide. The cathode active material is not limited to these examples, and may be any cathode active material available in the art.

In some embodiments, the cathode active material may be a compound selected from the group consisting of LiₐA_{1-b}B_{b}D₂ (where 0.90≦a≦1.8, and 0≦b≦0.5); LiₐE_{1-b}B_{b}O_{2-c}D_{c}, (where 0.90≦a≦1.8, 0≦b≦0.5, and 0≦c≦0.05); LiE_{2-b}B_{b}O_{4-c}D_{c} (where 0≦b≦0.5, and 0≦c≦0.05); LiₐNi_{1-b-c}Co_{b}B_{c}D_{α} (where 0.90≦a≦1.8, 0≦b≦0.5, 0≦c≦0.05, and 0≦α≦2); LiₐNi_{1-b-c}Co_{b}B_{c}O_{2-α}F_{α} (where 0.90≦a≦1.8, 0≦b≦0.5, 0≦c≦0.05, and 0≦α≦2); LiₐNi_{1-b-c}Co_{b}B_{c}O_{2-α}F₂ (where 0.90≦a≦1.8, 0≦b≦0.5, 0≦c≦0.05, and 0<α≦2); LiₐNi_{1-b-c}Mn_{b}B_{c}D_{α} (where 0.90≦a≦1.8, 0≦b≦0.5, 0≦c≦0.05, and 0≦α≦2); LiₐNi_{1-b-c}Mn_{b}B_{c}O_{2-α}F_{α} (where 0.90≦a≦1.8, 0≦b≦0.5, 0≦c≦0.05, and 0<α<2); LiₐNi_{1-b-c}Mn_{b}B_{c}O_{2-α}F₂ (where 0.90≦a≦1.8, 0≦b≦0.5, 0≦c≦0.05, and 0<α<2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GeO₂ (where 0.90≦a≦1.8, 0≦b≦0.9, 0≦c≦0.5, 0≦d≦0.5, and 0.001≦e≦0.1); LiₐNiG_{b}O₂ (where 0.90≦a≦1.8, and 0.001≦b≦0.1); LiₐCoG_{b}O₂ (where 0.90≦a≦1.8, and 0.001≦b≦0.1); LiₐMnG_{b}O₂ (where 0.90≦a≦1.8, and 0.001≦b≦0.1); LiₐMn₂G_{b}O₄ (where 0.90≦a≦1.8, and 0.001≦b≦0.1); QO₂; QS₂; LiQS₂; V₂O₅; LiV₂O₅; LiIO₂; LiNiVO₄; Li_{(3-f)}J₂(PO₄)₃ (0≦f≦2); Lio_{(3-f)}Fe₂(PO₄)₃ (0≦f≦2); and LiFePO₄.

In the formulae above, A is selected from the group consisting of nickel (Ni), cobalt (Co), manganese (Mn), and combinations thereof; B is selected from the group consisting of aluminum (Al), nickel (Ni), cobalt (Co), manganese (Mn), chromium (Cr), iron (Fe), magnesium (Mg), strontium (Sr), vanadium (V), a rare earth element, and combinations thereof; D is selected from the group consisting of oxygen (O), fluorine (F), sulfur (S), phosphorus (P), and combinations thereof; E is selected from the group consisting of cobalt (Co), manganese (Mn), and combinations thereof; F is selected from the group consisting of fluorine (F), sulfur (S), phosphorus (P), and combinations thereof; G is selected from the group consisting of aluminum (Al), chromium (Cr), manganese (Mn), iron (Fe), magnesium (Mg), lanthanum (La), cerium (Ce), strontium (Sr), vanadium (V), and combinations thereof; Q is selected from the group consisting of titanium (Ti), molybdenum (Mo), manganese (Mn), and combinations thereof; I is selected from the group consisting of chromium (Cr), vanadium (V), iron (Fe), scandium (Sc), yttrium (Y), and combinations thereof; and J is selected from the group consisting of vanadium (V), chromium (Cr), manganese (Mn), cobalt (Co), nickel (Ni), copper (Cu), and combinations thereof.

The compounds listed above as positive active materials may have a surface coating layer (hereinafter, “coating layer”). Alternatively, a mixture of a compound without the coating layer and a compound having the coating layer, the compounds being selected from the compounds listed above, may be used. The coating layer may include at least one compound of a coating element selected from the group consisting of oxide, hydroxide, oxyhydroxide, oxycarbonate, and hydroxycarbonate of the coating element. The compounds for the coating layer may be amorphous or crystalline. The coating element for the coating layer may be magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof. The coating layer may be formed using any method that does not adversely affect the physical properties of the cathode active material when a compound of the coating element is used. For example, the coating layer may be formed using a spray coating method, a dipping method, or the like. This will be obvious to those of ordinary skill in the art, and thus a detailed description thereof will be omitted.

Examples of the cathode active material include LiNiO₂, LiCoO₂, LiMnₓO₂ₓ (x=1, 2), LiNi₁₋ₓMnₓO₂ (0<x<1), LiNi_{1-x-y}COₓMn_{y}O₂ (0≦x≦0.5, 0≦y≦0.5), LiFeO₂, V₂O₅, TiS, and MoS.

Non-limiting examples of the water-soluble aqueous binder for the aqueous cathode slurry composition include carboxymethyl cellulose, styrene-butadiene rubber (SBR), acrylated SBR, polyvinyl alcohol, sodium polyacrylic acid, a copolymer of propylene and a C₂-C₈ olefin, a copolymer of (meth)acrylic acid and (meth)acrylic acid alkyl ester, and a combination thereof. Any aqueous binder available in the art may be used.

The cathode slurry composition may further include a conducting agent. The conducting agent may improve conductivity of the cathode material mixture.

As used herein, a cathode material mixture refers to a product of drying the cathode slurry composition, e.g., a combination of a cathode active material, a conducting agent, and a binder that may further include any additional components added to the cathode slurry composition.

Non-limiting examples of the conducting agent for the cathode slurry composition include acetylene black, ketjen black, natural graphite, artificial graphite, carbon black, carbon fiber, and metal powder and metal fiber of, for example, copper, nickel, aluminum or silver. In some embodiments at least one conducting material such as polyphenylene derivatives may be used in combination. Any conducting agent available in the art may be used.

The cathode slurry composition may further include a second binder. The second binder may bind the cathode composition material to a current collector.

The second binder may be at least one selected from the group consisting of polyvinylidene fluoride (PVDF), polytetrafluoroethylene (PTFE), and an acrylic copolymer. However, the second binder is not limited to these examples, and any binder available in the art that may bind the cathode composition material to the current collector may be used.

In an embodiment, the cathode slurry composition may be prepared as follows.

First, a cathode active material, a conducting agent, a first binder, and a non-transition metal oxide are mixed in water to prepare a mixture. Optionally, a second binder and/or water may be further added to the mixture and mixed together, thus preparing an aqueous cathode slurry composition.

According to another embodiment, a cathode includes a cathode composition layer formed using the cathode slurry composition described above, and an aluminum current collector.

Assuming that the cathode has a total thickness of about 200 μm or less and an area of about 3.2 cm² or less with the current collector having a thickness of about 20 μm or less and the cathode material mixture layer having a thickness of about 180 μm or less, the cathode may have a thickness-direction resistivity of about 18.2 Ω·m or less. In some embodiments when the cathode has a thickness of from about 74 μm to about 195 μm and an area of about 3.14 cm², the cathode may have a thickness-direction resistivity of from about 8 Ω·m to about 18.2 Ω·m. The aluminum current collector of the cathode may have a thickness of about 15 μm, and the cathode material mixture layer may have a thickness of from about 60 μm to about 180 μm.

In some embodiments the cathode may be manufactured by molding the cathode slurry composition in a desired shape, or by coating the cathode slurry composition on an aluminum foil current collector.

After the above-described cathode slurry composition is prepared, it is directly coated on an aluminum current collector to prepare a cathode plate. Alternatively, the cathode slurry composition may be cast on a separate support to form a cathode active material film, which may then be separated from the support and laminated on an aluminum current collector to prepare a cathode plate. The cathode is not limited to the examples described above, and may be one of a variety of types.

The amounts of the cathode active material, the conducting agent, the binder, and the solvent are those levels generally used in lithium batteries. At least one of the conducting agent, the binder and the solvent may not be used according to the use and the structure of the lithium battery.

According to another embodiment, a lithium battery includes the cathode. In an embodiment, the lithium battery may be manufactured as follows.

First, a cathode plate is prepared according to the above-described cathode preparation method.

Next, an anode active material, a conducting agent, a binder, and a solvent are mixed together to prepare an anode slurry composition. The anode slurry composition is directly coated on a metallic current collector and dried to prepare an anode plate. Alternatively, the anode slurry composition may be cast on a separate support to form an anode active material film, which may then be separated from the support and laminated on a metallic current collector to prepare an anode plate. In some embodiments, the anode slurry composition may further include a binder.

The anode active material is a compound that allows intercalation/deintercalation of lithium. Any material available as an anode active material in the art may be used. Non-limiting examples of the anode active material include a lithium metal, a lithium alloy, a metal alloyable with lithium or an oxide of the metal, a transition metal oxide, a carbonaceous material, graphite, and a mixture thereof.

Examples of the transition metal oxide include a vanadium oxide, a lithium vanadium oxide, and the like.

Examples of the metal alloyable with lithium or and its oxide include silicon (Si), SiOₓ wherein 0<x<2, an Si—Y alloy wherein Y is an alkali metal, an alkali earth metal, a Group XIII element, a Group XIV element, a transition metal, a rare earth element, or combinations thereof (except for Si), Sn, SnO₂, an Sn—Y alloy wherein Y is an alkali metal, an alkali earth metal, a Group XIII element, a Group XIV element, a transition metal, a rare earth element, or a combination thereof (except for Sn), and combinations of at least one of these materials and SiO₂. Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or combinations thereof.

Examples of the carbonaceous material and/or graphite include crystalline carbon, amorphous carbon, and mixtures thereof. Examples of the crystalline carbon include graphite, such as natural graphite or artificial graphite that are in amorphous, plate, flake, spherical or fibrous form. Examples of the amorphous carbon include soft carbon (carbon sintered at low temperatures), hard carbon, meso-phase pitch carbides, sintered corks, and the like.

The conducting agent, the binder and the solvent used for the anode slurry composition may be the same as or different from those used for the cathode slurry composition. The solvent may be water or an organic solvent. The binder may be an aqueous or non-aqueous binder.

Examples of the binder include a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer, but are not limited thereto. Any material available as a binding agent in the art may be used.

Non-limiting examples of the solvent include N-methyl-pyrrolidone, acetone, and water. Any material available as a solvent in the art may be used.

The amounts of the anode electrode active material, the conducting agent, the binder, and the solvent are those levels generally used in lithium batteries. At least one of the conducting agent, the binder and the solvent may not be used according to the use and the structure of the lithium battery.

Next, a separator to be disposed between the cathode and the anode is prepared. The separator may be any separator that is commonly used for lithium batteries. The separator may have low resistance to migration of ions in an electrolyte and have an excellent electrolyte-retaining ability. Examples of the separator include glass fiber, polyester, Teflon, polyethylene, polypropylene, polytetrafluoroethylene (PTFE), and a combination thereof, each of which may be a non-woven or woven fabric. For example, a rollable separator comprising polyethylene or polypropylene may be used for a lithium ion battery. A separator with a good organic electrolyte solution-retaining ability may be used for a lithium ion polymer battery. For example, the separator may be manufactured in the following manner.

A polymer resin, a filler, and a solvent may be mixed together to prepare a separator composition. Then, the separator composition may be directly coated on an electrode, and then dried to form the separator. Alternatively, the separator composition may be cast on a support and then dried to form a separator film, which may then be separated from the support and laminated on an electrode to form the separator.

The polymer resin used to manufacture the separator may be any material that is commonly used as a binder for electrode plates. Examples of the polymer resin include a vinylidenefluoride/hexafluoropropylene copolymer, polyvinylidene fluoride (PVDF), polyacrylonitrile, polymethylmethacrylate and a mixture thereof.

Next, an electrolyte is prepared.

For example, the electrolyte may be an organic electrolyte solution. Alternately, the electrolyte may be in a solid phase. Non-limiting examples of the electrolyte include lithium oxide and lithium oxynitride. Any material available as a solid electrolyte in the art may be used. The solid electrolyte may be formed on the anode by, for example, sputtering.

In some embodiments, an organic electrolyte solution may be prepared as follows. The organic electrolyte solution may be prepared by dissolving a lithium salt in an organic solvent.

The organic solvent may be any solvent available as an organic solvent in the art. Examples of the organic solvent include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, and mixtures thereof.

The lithium salt may be any material available as a lithium salt in the art. Examples of the lithium salt include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each independently a natural number), LiCl, LiI and a mixture thereof.

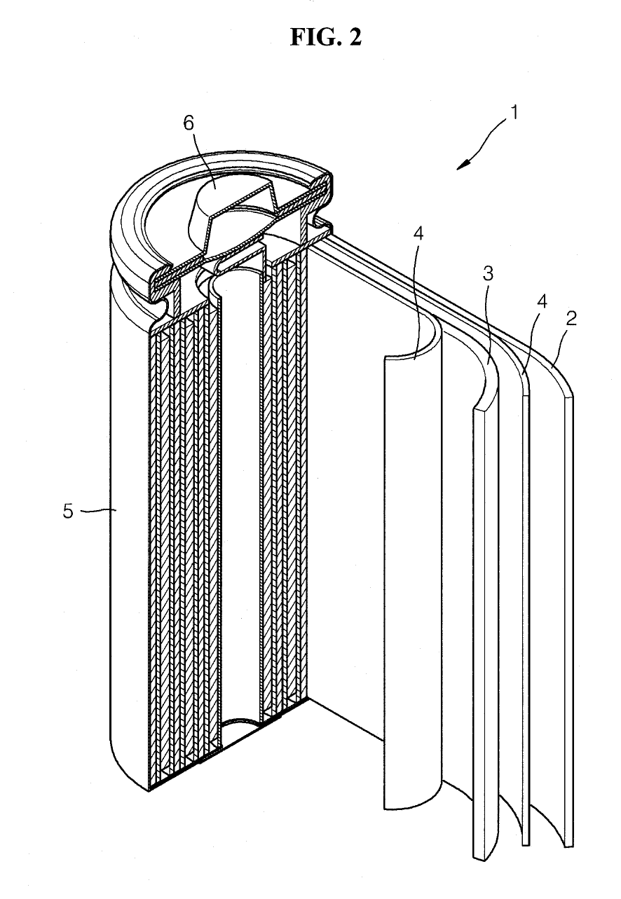

Referring to FIG. 2, a lithium battery 1 includes a cathode 3, an anode 2, and a separator 4. The cathode 3, the anode 2 and the separator 4 are wound or folded, and then sealed in a battery case 5. Then, the battery case 5 is filled with an organic electrolyte solution and sealed with a cap assembly 6, thereby completing the manufacture of the lithium battery 1. The battery case 5 may be a cylindrical type, a rectangular type, or a thin-film type. For example, the lithium battery may be a thin-film type battery. The lithium battery may be a lithium ion battery.

The separator may be interposed between the cathode and the anode to form a battery assembly. Alternatively, the battery assembly may be stacked in a bi-cell structure and impregnated with the electrolyte solution. The resultant is put into a pouch and hermetically sealed, thereby completing the manufacture of a lithium ion polymer battery.

Alternatively, a plurality of battery assemblies may be stacked to form a battery pack, which may be used in any device that operates at high temperatures and requires high output, for example, in a laptop computer, a smart phone, electric vehicle, and the like.

Thereinafter, one or more embodiments will be described in detail with reference to the following examples. However, these examples are not intended to limit the scope of the one or more embodiments.

### Preparation of Cathode Slurry Composition and Cathode

### Example 1

300 g of Li[Ni_{1/3}Co_{1/3}Mn_{1/3}]O₂ powder, 13.4 g of acetylene black, 3.3 g of carboxymethyl cellulose, 7 g of MgO nanopowder having an average particle diameter of about 800 nm, and 75 g of water were put into a mixer and mixed together to obtain a mixture. 70 g of water and 25 g of an acrylic copolymer emulsion (AX-4069, available from Zeon Co. Ltd., Japan) was added to the mixture and mixed together to prepare a cathode slurry composition.

The cathode slurry composition was coated on a 15 μm-thick aluminum substrate using a bar coater to a thickness of about 110 μm, and dried in an oven at about 110° C. for about 10 minutes, thereby manufacturing a cathode.

### Example 2

A cathode slurry composition and a cathode were prepared in the same manner as in Example 1, except that 3 g of MgO was used.

### Example 3

A cathode slurry composition and a cathode were prepared in the same manner as in Example 1, except that 15 g of MgO was used.

### Example 4

A cathode slurry composition and a cathode were prepared in the same manner as in Example 1, except that 30 g of MgO was used.

### Example 5

A cathode slurry composition and a cathode were prepared in the same manner as in Example 1, except that 35 g of MgO was used.

### Comparative Example 1

A cathode slurry composition and a cathode were prepared in the same manner as in Example 1, except that MgO was not added.

### Manufacture of Lithium Battery Half Cell

### Example 6

Using the cathode manufactured in Example 1, a coin cell (CR2032 type) of about 12 mm in diameter was manufactured.

Using a lithium metal as a counter electrode, a polytetrafluoroethylene (PTFE) separator, and an electrolyte comprising 1.3M LiPF₆ dissolved in a mixed solvent of ethylenecarbonate (EC) and diethylcarbonate (DEC) (in a 3:7 volume ratio), a CR-2032 standard coin cell was manufactured.

### Examples 7-10

Lithium batteries were manufactured in the same manner as in Example 6, except that the cathodes manufactured in Examples 1-5 were respectively used.

### Comparative Example 2

A lithium battery was manufactured in the same manner as in Example 6, except that the cathode manufactured in Comparative Example 1 was used.

### Evaluation Example 1

### Evaluation of Surface Appearance of Cathode

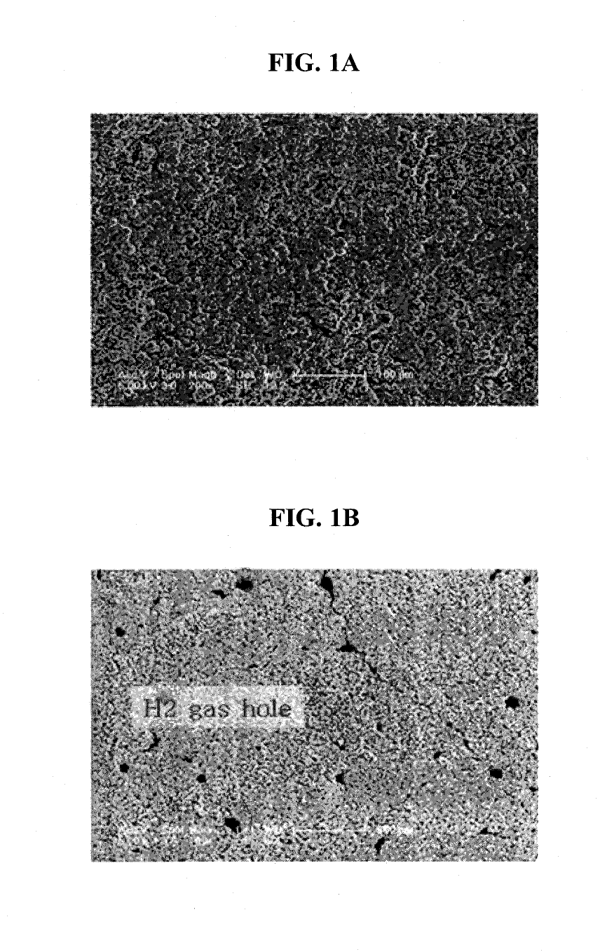

Surfaces of the cathodes of Example 1 and Comparative Example 1 were analyzed by scanning electron microscopy (SEM). The results are shown in FIGS. 1A and 1B, respectively.

The cathode of Example 1 does not have pores or cracks on its surface as shown in FIG. 1A, whereas the cathode of Comparative Example 1 was found to have pores or cracks on its surface as shown in FIG. 1B.

Thus, the addition of MgO is considered to have suppressed corrosion of aluminum.

### Evaluation Example 2

### Measurement of Resistivity

Resistivity was measured on the cathodes of Examples 1-5 and Comparative Example 1 in a thickness direction using a resistivity meter (available from CIS). The results are shown in Table 1 below.

Each of the cathodes had a total thickness of from about 75 μM to about 195 μm, and an area of about 3.14 cm² including a current of a thickness of about 15 μm and a cathode active material layer of a thickness of from about 60 μm to about 80 μm, and a circular sample having a radius of about 1 cm was used.

TABLE 1

| Example | Resistivity [Ω · m] |
|---|---|
| Example 1 | 8.8 |
| Example 2 | 10.2 |
| Example 3 | 11.5 |
| Example 4 | 13.6 |
| Example 5 | 18.1 |
| Comparative Example 1 | 18.6 |

Referring to Table 1, the cathodes of Examples 1-5 were found to have a lower resistivity as compared to that of Comparative Example 1, and those of Examples 1-4 have a markedly lower resistivity as compared to Comparative Example 1.

### Evaluation Example 3

### Impedance Measurement

Impedance was measured on the coin cells of Examples 6-10 and Comparative Example 2 using an impedance analyzer (Material Mates 7260 impedance analyzer) according to a 2-probe method. The measurement frequency range was from about 100 kHz to about 10 mHz, the sinus amplitude (Va) was 10 mV, and Pw (period before measurement at each frequency) was 0.1 sec. The results are shown in Table 2 below.

TABLE 2

| Example | Impedance [Ω] |
|---|---|
| Example 6 | 3.5 |
| Example 7 | 3.9 |
| Example 8 | 4.5 |
| Example 9 | 5.1 |
| Example 10 | 7.0 |
| Comparative Example 2 | 7.1 |

Referring to Table 2, the lithium batteries of Examples 6-10 were found to have a lower impedance than that of Comparative Example 2, and those of Examples 6-9 have a markedly lower impedance as compared to that of Comparative Example 2.

### Evaluation Example 4

### Evaluation of Charge-Discharge Characteristics

The coin cells of Examples 6-10 and Comparative Example 2 were each subjected to 100 charge-discharge cycles at 25° C. and a constant current of 4.4 mA/g (1.0 C rate) in a voltage range of from 3.0 V to 4.3 V with respect to lithium metal. The results of charging and discharging at room temperature are shown in Table 3 below. A capacity retention rate was calculated using Equation 1 below.

Capacity retention rate (%)=[100^{th} cycle discharge capacity/1^{st} cycle discharge capacity]×100 Equation 1

TABLE 3

| | Capacity retention ratio (%) |
|---|---|
| Example 6 | 98.7 |
| Example 7 | 87.4 |
| Example 8 | 79.6 |
| Example 9 | 76.2 |
| Example 10 | 67.3 |
| Comparative Example 2 | 61.5 |

Referring to Table 1, the lithium batteries of Examples 6-10 and Comparative Example 2 exhibit improved cycle characteristics (capacity retention ratio), as compared to that of Comparative Example 2.

As described above, according to the one or more of the above embodiments, a cathode slurry composition comprising a non-transition metal oxide may prevent corrosion of an aluminum current collector. Therefore, when including a cathode formed using the cathode slurry composition, a lithium battery may have reduced resistance and improved lifetime characteristics.

It should be understood that the example embodiments described herein should be considered in a descriptive sense only and not for purposes of limitation. Descriptions of features or aspects within each embodiment should typically be considered as available for other similar features or aspects in other embodiments.

What is claimed is:

1. A cathode slurry composition comprising:
an aqueous binder;
a cathode active material; and
a non-transition metal oxide.

2. The cathode slurry composition of claim 1, wherein the non-transition metal oxide comprises an oxide of at least one element selected from the group consisting of lithium (Li), beryllium (Be), boron (B), sodium (Na), magnesium (Mg), aluminum (Al), silicon (Si), potassium (K), calcium (Ca), gallium (Ga), germanium (Ge), arsenic (As), selenium (Se), rubidium (Rb), strontium (Sr), indium (In), tin (Sn), antimony (Sb), tellurium (Te), cesium (Cs), barium (Ba), thallium (Tl), lead (Pb), bismuth (Bi), and polonium (Po).

3. The cathode slurry composition of claim 1, wherein the non-transition metal oxide comprises at least one selected from the group consisting of MgO, SiO₂, Al₂O₃, In₂O₃, and SnO₂.

4. The cathode slurry composition of claim 1, wherein the non-transition metal oxide has an average particle diameter of about 1 μm or less.

5. The cathode slurry composition of claim 1, wherein an amount of the non-transition metal oxide is from about 1 part to about 15 parts by weight based on 100 parts by weight of the cathode active material.

6. The cathode slurry composition of claim 1, wherein the cathode active material comprises at least one selected from the group consisting of lithium cobalt oxide, lithium nickel cobalt manganese oxide, lithium nickel cobalt aluminum oxide, lithium iron phosphorous oxide, and lithium manganese oxide.

7. The cathode slurry composition of claim 1, wherein the aqueous binder comprises at least one selected from the group consisting of carboxymethyl cellulose, styrene-butadiene rubber (SBR), acrylated SBR, polyvinyl alcohol, sodium polyacrylic acid, a copolymer of propylene and a C₂-C₈ olefin, and a copolymer of (meth)acrylic acid and (meth)acrylic acid alkyl ester.

8. The cathode slurry composition of claim 1, wherein the cathode slurry composition further comprises a conducting agent.

9. The cathode slurry composition of claim 8, wherein the conducting agent comprises at least one selected from the group consisting of natural graphite, artificial graphite, carbon black, acetylene black, ketjen black, carbon fiber, metal powder, metal fiber, and polyphenylene derivatives.

10. The cathode slurry composition of claim 1, wherein the cathode slurry composition further comprises a second binder.

11. The cathode slurry composition of claim 10, wherein the second binder comprises at least one selected from the group consisting of polyvinylidene fluoride (PVDF), polytetrafluoroethylene (PTFE), and an acrylic copolymer.

12. A cathode comprising:
an aluminum current collector; and
a cathode composition layer formed using a cathode slurry composition comprising:
an aqueous binder;
a cathode active material; and
a non-transition metal oxide.

13. The cathode of claim 12, wherein the cathode has a total thickness of about 200 μm or less and an area of about 3.2 cm² or less with the current collector having a thickness of about 20 μM or less and the cathode material mixture layer having a thickness of about 180 μm or less.

14. The cathode of claim 12, wherein the cathode has a thickness-direction resistivity of about 18.2 Ω·m or less.

15. A lithium battery comprising the cathode of claim 12.

16. The cathode of claim 12, wherein the non-transition metal oxide comprises an oxide of at least one element selected from the group consisting of lithium (Li), beryllium (Be), boron (B), sodium (Na), magnesium (Mg), aluminum (Al), silicon (Si), potassium (K), calcium (Ca), gallium (Ga), germanium (Ge), arsenic (As), selenium (Se), rubidium (Rb), strontium (Sr), indium (In), tin (Sn), antimony (Sb), tellurium (Te), cesium (Cs), barium (Ba), thallium (Tl), lead (Pb), bismuth (Bi), and polonium (Po).

17. The cathode of claim 12, wherein the non-transition metal oxide comprises at least one selected from the group consisting of MgO, SiO₂, Al₂O₃, In₂O₃, and SnO₂.

18. The cathode of claim 12, wherein the non-transition metal oxide has an average particle diameter of about 1 μm or less.

19. The cathode of claim 12, wherein an amount of the non-transition metal oxide is from about 1 part to about 15 parts by weight based on 100 parts by weight of the cathode active material.

20. The cathode of claim 12, wherein the cathode active material comprises at least one selected from the group consisting of lithium cobalt oxide, lithium nickel cobalt manganese oxide, lithium nickel cobalt aluminum oxide, lithium iron phosphorous oxide, and lithium manganese oxide.
